(19) United States
(12) Patent Application Publication
(10) Pub. No.: US 2014/0102389 A1
(43) Pub. Date: Apr. 17, 2014

(54) INTERNAL COMBUSTION ENGINE VALVE DRIVE DEVICE FOR A MOTOR VEHICLE

(71) Applicant: DAIMLER AG, Stuttgart (DE)

(72) Inventors: Thomas Stolk, Kirchheim (DE); Alexander VON GAISBERG-HELFENBERG, Beilstein (DE)

(73) Assignee: DAIMLER AG, Stuttgart (DE)

(21) Appl. No.: 14/106,750

(22) Filed: Dec. 14, 2013

Related U.S. Application Data
(63) Continuation-in-part of application No. PCT/EP2011/006300, filed on Dec. 14, 2011.

(30) Foreign Application Priority Data
Jun. 16, 2011 (DE) 10 2011 104 382.2

(51) Int. Cl. F02D 13/02

(52) U.S. Cl. CPC F02D 13/02
USPC 123/90.15; 123/90.1

(57) ABSTRACT

In an internal combustion engine valve drive device having at least one switch gate for valve lift switching by converting a rotation of at least a first and a second cam element into an axial movement by first and second actuators provided for axially displacing the first cam element and the second cam element in a first switching direction via an operative connection of the first actuator with the switch gate and the second actuator provided for axially displacing the second cam element in the same switching direction via an operative connection with the switch gate, the device including a control unit controlling the axial displacement of the first and second cam elements in the same switching direction under the control unit by actuating the first and second actuators at the same time.

This is a Continuation-In-Part application of pending international patent application PCT/EP2011/006300 filed Dec. 14, 2011 and claiming the priority of German patent application 10 2011 104 382.2 filed Jun. 16, 2011.

### BACKGROUND OF THE INVENTION

The invention relates to an internal combustion engine valve drive device which has at least one switch gate for axially displacing cam elements so as to provide for operation of the engine valves with different lift cams.

DE 10 2009 006 632 A1 discloses an internal combustion engine valve drive device for a motor vehicle with at least one switch gate which, for valve lift switching, is adapted to convert rotary motion of at least one cam element into an axial motion of the at least one cam element. The device has at least one actuator which is provided for axially displacing a first cam element in a switching direction via an operative connection with the switch gate, and a second actuator which is provided for axially displacing the cam element in an opposite switching direction via an operative connection with the switch gate. A control unit for controlling the switching operation is also provided.

It is the object of the present invention in particular to reduce costs of the internal combustion engine valve drive device.

### SUMMARY OF THE INVENTION

In an internal combustion engine valve drive device having at least one switch gate for valve lift switching by converting a rotation of at least a first and a second cam element into an axial movement by first and second actuators provided for axially displacing the first cam element and the second cam element in a first switching direction via an operative connection of the first actuator with the switch gate and the second actuator provided for axially displacing the second cam element in the same switching direction via an operative connection with the switch gate, the device including a control unit controlling the axial displacement of the first and second cam elements in the same switching direction under the control unit by actuating the first and second actuators at the same time.

For axially displacing the at least two cam elements in the same switching direction, the control unit is provided for simultaneously controlling and/or monitoring the at least two actuators. In this way, particularly advantageous control and/or monitoring of all actuators which are provided for axially displacing the cam elements in the same switching direction, i.e., at least the first actuator and the second actuator, may be achieved, so that all actuators for initializing a switching direction may be simultaneously controlled and/or monitored, and therefore coding of the switching of the cam elements may be achieved. As a result, in the event of failure of one actuator, all actuators may be deactivated, so that either all cam elements or none of the cam elements are axially displaced, and thus, only corresponding operating states may be established. An incorrect and/or incomplete axial displacement of the cam elements, and thus incorrect and/or incomplete lift switching, can be avoided.

The control unit is preferably provided for simultaneously controlling and/or monitoring all actuators which are provided for the same switching direction. Due to simultaneously controlling all actuators which are provided for the same switching direction, the control provided for controlling and/or monitoring the actuators may be simplified, so that in particular the number of control and/or output stages or outputs of the control unit may be reduced. As a result, costs of the internal combustion engine valve drive device may be reduced, and therefore a reliable and economical internal combustion engine valve drive device may be provided. In principle, the internal combustion engine valve drive device may have, in addition to the first actuator and the second actuator, further actuators which are provided for the same switching direction, each of which is provided for axially displacing a further cam element, in addition to the first cam element and the second cam element, in the switching direction which corresponds to the switching direction provided by the first actuator and the second actuator, via an operative connection with the switch gate. In the present context, “all actuators” is understood to mean in particular all actuators, i.e., at least the first actuator and the second actuator, which are associated with the same camshaft, for example an exhaust camshaft or an intake camshaft, for displacement in at least one switching direction, and thus, all actuators which are provided on the same camshaft for lift switching in a particular switching direction.

A “switch gate” is understood to mean a switching unit for axially displacing at least one cam element, which has at least one gate track that is provided for converting a rotary motion into an axial adjusting movement. A “gate track” is understood in particular to mean a track for forced guidance arranged on at least one side, preferably on both sides, of a switching element, in particular a switch pin. The gate track is preferably in the form of a web, or in the form of a slot, or in the form of a groove. The switching element is preferably in the form of a shifting shoe which surrounds the web, in the form of a pin which engages in the slot, or in the form of a pin which is guided in the groove.

The term “lift switching” is understood in particular to mean a discrete switch between at least two valve actuation cams which provide for an actuation of a gas exchange valve of an internal combustion engine having the internal combustion engine valve drive device. A “rotary motion and/or axial motion” is understood in particular to mean a rotary motion and/or axial motion with regard to a rotational axis of the camshaft. A “cam element” is understood in particular to mean an element which has at least one cam for actuating at least one gas exchange valve of the internal combustion engine and which forms the at least one valve actuation curve. An “operative connection” is understood in particular to mean a positive-fit operative connection by means of which the rotary motion is converted into the axial motion. A “switching direction” is understood in particular to mean an axial direction of motion of a cam element with respect to the rotational axis of the camshaft, the lift switching occurring due to a movement of the cam element in the direction of motion and being defined by the operative connection of the actuator with the switch gate, in particular with the corresponding gate track of the switch gate. A “control unit” is understood in particular to mean a unit having at least one control device. A “control device” is understood in particular to mean a unit having a processor unit and a memory unit as well as an operating program that is stored in the memory unit. In principle, the control unit may have multiple interconnected control devices which preferably are provided for communicating with one another via a bus system, such as a CAN bus system in particular. The term “the same switching direction” is understood in particular to mean an axial direction of motion of the at least two cam elements in the same direction, in the sense that the valve actuation curves are switched from a first operating mode, for example a high load of the internal combustion engine, to a second operating mode, for example a low load of the internal combustion engine, wherein for error-free and/or complete axial displacement, and thus for error-free and/or complete lift switching, all cam elements must be displaced in the same or opposite axial direction of motion, in particular sequentially. In the present context, the term “all cam elements” is understood in particular to mean all cam elements, i.e., at least the first cam element and the second cam element, that are associated with the same camshaft, for example an exhaust camshaft or an intake camshaft, and thus, all cam elements that are provided for the lift switching on the same camshaft. The term “provided” is understood in particular to mean specially programmed, designed, equipped, and/or situated.

It is further proposed that at least the first actuator and the second actuator are electrically connected to one another in parallel or in series. Simultaneous control and/or monitoring may thus be achieved in a particularly simple manner.

In one advantageous embodiment, the control unit has a control and/or output stage which is simultaneously connected to the at least two actuators, which are provided for axially displacing the at least two cam elements in the same switching direction, as the result of which costs may be reduced in a particularly simple manner. An “output stage” is understood in particular to mean a unit on the output side via which at least one actuator is controlled and/or monitored and/or which is provided for supplying the at least one actuator with sufficient power for the control and in particular for amplifying an output signal for the at least one actuator which is output by a microprocessor (CPU). A control stage is understood in particular to mean a unit that is connected upstream from one or more output stages.

It is further proposed that, for axially displacing the at least two cam elements, the control unit is provided for simultaneously controlling and/or monitoring, regardless of a switching direction of the actuators, the at least two actuators and at least one third actuator, which is provided for axially displacing the first cam element and/or the second cam element in a switching direction oriented opposite the switching direction provided by the first actuator and the second actuator, via an operative connection with the switch gate. Particularly advantageous control and/or monitoring of all actuators, which are provided for the two opposite switching directions, may thus be achieved. The term “regardless of a switching direction” is understood in particular to mean that all actuators, no matter which switching direction they are provided for, are controlled and/or monitored, and/or, no matter in which switching direction the cam elements are to be displaced, all actuators, and thus at least the first actuator, the second actuator, and the third actuator, are controlled and/or monitored. The term “switching direction provided by an actuator” is understood in particular to mean a switching direction that results due to the operative connection of the actuator with the switch gate.

It is further proposed that at least the third actuator is electrically connected in parallel or in series with the first actuator and the second actuator, and is provided for axially displacing the first cam element and/or the second cam element in a switching direction oriented opposite the switching direction provided by the first actuator and the second actuator, via an operative connection with the switch gate. In this way, all actuators which are provided for axially displacing all cam elements in both opposite switching directions may easily be simultaneously controlled and/or monitored, so that costs may further reduced. In principle, the internal combustion engine valve train device may have, in addition to the third actuator, further actuators which are provided for the same switching direction, and which are each provided for axially displacing a further cam element in the switching direction opposite the switching direction provided by the first actuator and the second actuator, via an operative connection with the switch gate.

In particular, it is advantageous for the control and/or output stage to be simultaneously connected to the at least three actuators which are provided for axially displacing the at least two cam elements in the two opposite switching directions. Costs may thus be further reduced in a particularly simple manner.

In one alternative embodiment according to the invention, the internal combustion engine valve train device has at least one third actuator which is connected electrically separate from the first actuator and the second actuator, and is provided for axially displacing the first cam element and/or the second cam element in a switching direction oriented opposite the switching direction provided by the first actuator and the second actuator, via an operative connection with the switch gate. A particularly advantageous internal combustion engine valve train device may thus be provided in which only the actuators which are provided for axially displacing the cam elements in the same switching direction are jointly controlled and/or monitored, i.e., in which the simultaneous control and/or monitoring of the actuators occurs for each switching direction. The term “electrically separate” is understood in particular to mean that at least the third actuator is controlled and/or monitored independently from the first actuator and the second actuator, and is controlled and monitored individually.

It is advantageous for the control and/or output stage to be simultaneously connected only to at least the first actuator and the second actuator, and thus only to the actuators that are provided for the same switching direction, so that only a single control and/or output stage, in particular a single output stage for each switching direction, is required, in particular regardless of the number of actuators, and thus regardless of the number of cam elements.

In particular, it is advantageous when the internal combustion engine valve train device has at least one fourth actuator which is electrically connected in parallel or in series with the third actuator, and which is provided for axially displacing the first cam element or the second cam element in the switching direction which corresponds to the switching direction provided by the third actuator, via an operative connection with the switch gate. At least the first cam element and the second cam element may thus be axially displaced in the two switching directions in a particularly advantageous manner.

It is also advantageous when the control unit has a further control and/or output stage which is connected at least to the third actuator. Particularly advantageous control and/or monitoring of the actuators may thus be achieved in which all actuators having the same switching direction are simultaneously controlled and/or monitored, but independently of all actuators having the opposite switching direction. The further control and/or output stage is preferably simultaneously connected to all actuators which are provided for providing a switching direction that corresponds to the switching direction provided by the third actuator, and is therefore simultaneously connected at least to the third actuator and the fourth actuator.

In addition, a method for lift switching in an internal combustion engine of a motor vehicle by means of an internal combustion engine valve drive device, in particular an internal combustion engine valve drive device according to the invention, is proposed in which a first cam element is axially displaced in a switching direction by means of an operative connection of a first actuator with a switch gate, and a second cam element is axially displaced in the same switching direction by means of an operative connection of a second actuator with the switch gate, at least the first actuator and the second actuator being simultaneously controlled for axially displacing the at least two cam elements. In this way, all actuators which are provided for axially displacing all cam elements in the same switching direction, i.e., at least the first actuator and the second actuator, and thus all actuators for initializing a switching direction, may be simultaneously controlled and/or monitored in a particularly advantageous manner by means of only one control and/or output stage, in particular by means of only one output stage, so that costs of the internal combustion engine valve train device may be reduced.

Below, two exemplary embodiments of the invention are illustrated with reference to the accompanying drawings. The drawings, the description, and the claims contain numerous features in combination. Those skilled in the art will also advantageously consider the features individually and combine them into further meaningful combinations.

### BRIEF DESCRIPTION OF THE DRAWING

FIG. 1 shows an internal combustion engine valve drive device having four actuators electrically connected in parallel; and

FIG. 2 shows an internal combustion engine valve drive device having four actuators of which in each case two actuators are electrically connected to one another in series.

### DESCRIPTION OF EXEMPLARY EMBODIMENTS

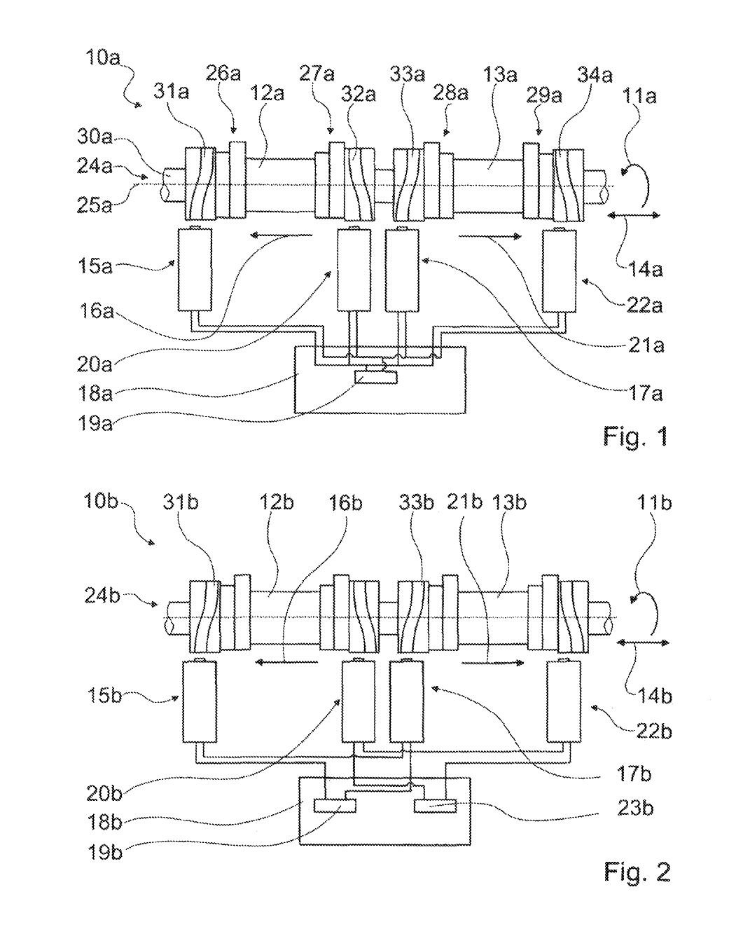

FIG. 1 schematically shows an internal combustion engine valve drive device for a motor vehicle. The internal combustion engine valve drive device has a camshaft 24a for actuating gas exchange valves of the internal combustion engine. The camshaft 24a is an intake camshaft. The internal combustion engine valve drive device has further an exhaust camshaft, not illustrated, which in principle may be controlled or monitored analogously to the intake camshaft 24a. In principle, the internal combustion engine valve drive device may have further camshafts which are analogously controlled or monitored.

The camshaft 24a has two axially displaceable cam elements 12a, 13a. The cam elements 12a, 13a are displaceable along a rotational axis 25a of the camshaft 24a. The cam elements 12a, 13a are each designed as a cam support. Two cams 26a, 27a are situated on the cam element 12a and two cams 28a, 29a are situated on the cam element 13a, the cams in each case having two partial cams with different valve actuation curves. The partial cams of each of the cams 26a, 27a, 28a, 29a are in each case situated directly adjacent to one another. A switch is made within the cam 26a, 27a, 28a, 29a from one partial cam to the other partial cam by an axial displacement of the respective cam elements 12a, 13a. Each of the cam elements 12a, 13a thus has two discrete switching positions in which a different valve lift is switched for one or more cylinders associated with the corresponding cam element 12a, 13a. The cams 26a, 27a, 28a, 29a may be designed in one piece with the respective cam element 12a, 13a, or may be situated thereon in a nondisplaceable and rotationally fixed manner. In principle, the camshaft 24a may also have further cam elements having at least one cam.

The camshaft 24a includes a drive shaft 30a for supporting the cam elements 12a, 13a. The drive shaft 30a includes a crankshaft connection for connection to a crankshaft, not illustrated in greater detail, of the internal combustion engine. The crankshaft connection may be formed by means of a camshaft adjuster which is provided for setting a phase position between the camshaft 24a and the crankshaft of the engine.

The cam elements 12a, 13a are axially displaceable and disposed on the drive shaft 30a in a rotationally fixed manner. The drive shaft 30a has spur toothing on its outer periphery. The cam elements 12a, 13a have corresponding spur toothing on their inner periphery which engages with the spur toothing of the drive shaft 30a.

For the lift switching, the internal combustion engine valve drive device has a switch gate 10a which is provided for converting a rotary motion 11a of the cam elements 12a, 13a into an axial motion 14a of the cam elements 12a, 13a. The switch gate 10a is provided for sequentially axially displacing the two cam elements 12a, 13a one after the other in a switching operation. The switch gate 10a includes four gate tracks 31a, 32a, 33a, 34a for displacing the cam elements 12a, 13a in two mutually opposite switching directions 16a, 21a. The gate tracks 31a, 32a, 33a, 34a each extend around a cam element 12a, 13a, and thus, about the rotational axis 25a. The gate tracks 31a, 32a are associated with the first cam element 12a, and are situated on the first cam element 12a. The gate tracks 33a, 34a are associated with the second cam element 13a, and are situated on the second cam element 13a. The gate tracks 31a, 33a have an identical design with respect to the associated cam element 12a, 13a, and the gate tracks 32a, 34a have an identical design with respect to the associated cam element 12a, 13a. The gate track 31a is provided for axially displacing the first cam element 12a in the switching direction 16a, and the gate track 33a is provided for axially displacing the second cam element 13a in the same switching direction 16a. The gate tracks 31a, 33a are provided for the switching direction 16a. The gate track 32a is provided for axially displacing the first cam element 12a in the switching direction 21a, and the gate track 34a is provided for axially displacing the second cam element 13a in the same switching direction 21a. The gate tracks 32a, 34a are provided for the switching direction 21a.

The internal combustion engine valve drive device has four actuators 15a, 17a, 20a, 22a for axially displacing the cam elements 12a, 13a in both switching directions 16a, 21a and for actuating the cam elements 12a, 13a. The actuators 15a, 17a are provided for the same switching direction 16a, and are referred to below as the first actuator 15a and the second actuator 17a. These actuators provide the same switching direction 16a. The first actuator 15a is provided for axially displacing the first cam element 12a in the switching direction 16a via an operative connection with the gate track 31a of the switch gate 10a. The second actuator 17a is provided for axially displacing the second cam element 13a in the same switching direction 16a via an operative connection with the gate track 33a of the switch gate 10a.

The actuators 20a, 22a are provided for the same switching direction 21a, which extends opposite the switching direction 16a, and are referred to below as the third actuator 20a and the fourth actuator 22a. These actuators provide the same switching direction 21a, which is opposite the switching direction 16a provided by the first actuator 15a and the second actuator 17a. The third actuator 20a is provided for axially displacing the first cam element 12a in the switching direction 21a via an operative connection with the gate track 32a of the switch gate 10a. The fourth actuator 22a is provided for axially displacing the second cam element 13a in the same switching direction 21a via an operative connection with the gate track 34a of the switch gate 10a.

Each of the four actuators 15a, 17a, 20a, 22a has a switch pin for the operative connection with the switch gate 10a. For establishing the operative connection, the switch pins of the actuators 15a, 17a, 20a, 22a are each brought into engagement with the corresponding gate track 31a, 32a, 33a, 34a. The actuators 15a, 17a, 20a, 22a each have a stator housing which is fixedly connected to an engine block, not illustrated in greater detail, of the internal combustion engine. The switch pins are each situated in the corresponding stator housing so as to be displaceable along their main direction of extension. For actuating and thus extending the switch pins, each of the four actuators 15a, 17a, 20a, 22a has a coil which is energized to generate a magnetic field, thus moving the corresponding switch pin from the stator housing.

The gate tracks 31a, 32a, 33a, 34a are each designed as a groove in which the corresponding switch pin is be forcibly guided on both sides. For an axial displacement of the first cam element 12a in the switching direction 16a, the switch pin of the first actuator 15a is brought into engagement with the gate track 31a of the switch gate 10a. The actuator 15a provides the switching direction 16a due to the engagement of its switch pin with the gate track 31a, and thus via an operative connection with the switch gate 10a. For an axial displacement of the second cam element 13a in the switching direction 16a, the switch pin of the second actuator 17a is brought into engagement with the gate track 33a of the switch gate 10a. The actuator 17a provides the switching direction 16a due to the engagement of its switch pin with the gate track 33a, and thus via an operative connection with the switch gate 10a. For an axial displacement of the first cam element 12a in the switching direction 21a, the switch pin of the third actuator 20a is brought into engagement with the gate track 32a of the switch gate 10a. The actuator 20a provides the switching direction 21a due to the engagement of its switch pin with the gate track 32a, and thus via an operative connection with the switch gate 10a. For an axial displacement of the second cam element 13a in the switching direction 21a, the switch pin of the fourth actuator 22a is brought into engagement with the gate track 34a of the switch gate 10a. The actuator 22a provides the switching direction 21a due to the engagement of its switch pin with the gate track 34a, and thus via an operative connection with the switch gate 10a.

In the present exemplary embodiment, all four actuators 15a, 17a, 20a, 22a are electrically connected to one another in parallel. The actuators 15a, 17a, 20a, 22a are electrically connected to one another in parallel, regardless of which switching direction 16a, 21a they are provided for. The actuators 15a, 17a, 20a, 22a are controllable only jointly and simultaneously. The coils of the actuators 15a, 17a, 20a, 22a are connected to one another in parallel and are therefore energized in parallel and thus simultaneously. As a result, all switch pins are simultaneously extended, regardless of the switching direction 16a, 21a to be switched, whereby the switch pins which are provided for the wrong switching direction 16a, 21a are each pushed back into the corresponding stator housing by an ejection ramp of the particular gate track 31a, 32a, 33a, 34a.

The internal combustion engine valve train device has a control unit 18a for controlling and monitoring the four actuators 15a, 17a, 20a, 22a. The control unit 18a simultaneously controls and monitors all four actuators 15a, 17a, 20a, 22a for axially displacing the two cam elements 12a, 13a in the switching direction 16a and in the switching direction 21a. The control unit 18a simultaneously controls and monitors all actuators 15a, 17a, 20a, 22a for axially displacing the two cam elements 12a, 13a, regardless of the switching direction 16a, 21a. The control unit 18a simultaneously energizes all coils of the actuators 15a, 17a, 20a, 22a for controlling, and thus for actuating, the actuators 15a, 17a, 20a, 22a, so that all switch pins are simultaneously extended regardless of the switching direction 16a, 21a. In principle, the control unit 18a may also only control or only monitor the actuators 15a, 17a, 20a, 22a.

Due to the simultaneous monitoring of all four actuators 15a, 17a, 20a, 22a, the control unit 18a detects a defective or nonfunctional actuator 15a, 17a, 20a, 22a, for example a defective or disconnected electrical connection to the actuators 15a, 17a, 20a, 22a, as the result of which the control unit 18a deactivates all actuators 15a, 17a, 20a, 22a and thus prevents an undefined mixed state of the cam elements 12a, 13a. The control and regulation unit 18a deactivates the actuators 15a, 17a, 20a, 22a, for example by deactivating energization of the coils of the actuators 15a, 17a, 20a, 22a. In principle, the control and regulation unit 18a may be provided for outputting an error message, for example by actuating a visual, acoustic, and/or haptic warning element in a motor vehicle interior, when a defective or nonfunctional actuator 15a, 17a, 20a, 22a is detected.

The control unit 18a has only one output stage 19a for controlling and monitoring all actuators 15a, 17a, 20a, 22a. The output stage 19a is simultaneously connected to the four actuators 15a, 17a, 20a, 22a, which are provided for axially displacing the two cam elements 12a, 13a in both switching directions 16a, 21a. The output stage 19 is thus simultaneously connected to the two actuators 15a, 17a, which are provided for axially displacing the two cam elements 12a, 13a in the switching direction 16a, as well as to the two actuators 20a, 22a, which are provided for axially displacing the two cam elements 12a, 13a in the opposite switching direction 21a. In principle, the output stage 19a may also be designed as a control stage.

In an operating state in which the cam elements 12a, 13a are to be axially displaced for lift switching in the switching direction 16a, the control unit 18a controls the actuators 15a, 17a, 20a, 22a, which are connected in parallel, and thus simultaneously controls the actuators 15a, 17a which are provided for the desired switching direction 16a, and the actuators 20a, 22a, which are provided for the opposite switching direction 21a, so that the coils of all actuator 15a, 17a, 20a, 22a, are simultaneously energized and therefore the switch pins are simultaneously extended by each actuator 15a, 17a, 20a, 22a. The switch pins of the actuators 15a, 17a, which are associated with the correct switching direction 16a, simultaneously engage with the corresponding gate track 31a, 33a, so that the actuator 15a and the actuator 17a are in operative connection with the switch gate 10a, and the cam elements 12a, 13a are sequentially axially displaced in the switching direction 16a due to the rotary motion 11a of the camshaft 24a. The switch pins of the actuators 20a, 22a, which are associated with the opposite switching direction 21a, are immediately pushed back into the corresponding stator housing of the actuator 20a, 22 by the ejection ramp of the respective gate track 32a, 34a without having caused an axial displacement of the cam elements 12a, 13a, so that the actuators 20a, 22a remain deactivated. If an electrical connection between an actuator 15a, 17a, 20a, 22a is defective or disconnected, and therefore the circuit between one of the actuators 15a, 17a, 20a, 22a is interrupted, the control unit 18a detects a defective actuator 15a, 17a, 20a, 22a and deactivates the remaining actuators 15a, 17a, 20a, 22a. The axial displacement, and therefore the lift switching, is interrupted or stopped in the switching direction 16a, thus preventing incomplete axial displacement of the cam elements 12a, 13a and allowing a defined state to be associated with the cam elements 12a, 13a, and thus with the internal combustion engine. The same analogously applies for an operating state in which the cam elements 12a, 13a are to be axially displaced for lift switching in the switching direction 21a.

In principle, it is possible for only the actuators 15a, 17a, 20a, 22a which are provided for providing the same switching direction 16a, 21a to be connected to one another in parallel. With reference to the above-described exemplary embodiment, the first actuator 15a and the second actuator 17a, which are both provided for axially displacing the two cam elements 12a, 13a in the same switching direction 16a, would then be connected to one another in parallel, and the third actuator 20a and the fourth actuator 22a, which are both provided for axially displacing the two cam elements 12a, 13a in the same switching direction 21a opposite the switching direction 21a would then be connected to one another in parallel. The actuators 15a, 17a are connected electrically separate from the actuators 20a, 22a. The actuators 15a, 17a are electrically connected, independently of the actuators 20a, 22a. The coils of the actuators 15a, 17a are connected to one another in parallel, and the coils of the actuators 20a, 22a are connected to one another in parallel. For axially displacing the cam elements 12a, 13a in the switching direction 16a, the control unit 18a controls and monitors the actuators 15a, 17a, and for axially displacing the cam elements 12a, 13a in the switching direction 21a, simultaneously controls and monitors the actuators 20a, 22a. The control unit simultaneously controls either the actuators 15a, 17a or the actuators 20a, 22a, for the respective switching direction 16a, or 21a. For this purpose, the control unit 18a has an output stage which is simultaneously connected to the first actuator 15a and the second actuator 17a, and has an output stage which is simultaneously connected to the third actuator 20a and the fourth actuator 22a. The control 18a thus has an output stage for each switching direction 16a, 21a.

Another exemplary embodiment of the invention is shown in FIG. 2. The following description is essentially limited to the differences between the exemplary embodiments, whereby reference may be made to the description of the other exemplary embodiment, in particular FIG. 1, with regard to components, features, and functions which remain the same. For distinguishing the exemplary embodiments, the letter “a” in the reference numerals of the exemplary embodiment in FIG. 1 is replaced by the letter “b” in the reference numerals of the exemplary embodiment in FIG. 2. Basically, reference may be also made to the drawing and/or the description of the exemplary embodiment in FIG. 1 with regard to components denoted in the same way, in particular with regard to components having the same reference numerals.

An alternative design of an internal combustion engine valve train device of a motor vehicle is illustrated in FIG. 2, showing a switch gate 10b which for lift switching is provided to convert a rotary motion 11b of two cam elements 12b, 13b into an axial motion 14b of the cam elements 12b, 13b. In contrast to the preceding exemplary embodiment, the internal combustion engine valve drive device has four actuators 15b, 17b, 20b, 22b, which for each switching direction 16b, 21b are electrically connected to one another in series.

The actuators 15b, 17b, which are provided for providing the same switching direction 16b, are electrically connected to one another in series, and the actuators 20b, 22b, which are provided for providing the opposite switching direction 21b, are likewise electrically connected to one another in series. Thus, the first actuator 15b and the second actuator 17b, which are each provided for axially displacing a cam element 12b, 13b in the switching direction 16b, are electrically connected to one another in series. In addition, the third actuator 20b and the fourth actuator 22b, which are each provided for axially displacing a cam element 12b, 13b in the switching direction 21b, are electrically connected to one another in series.

The third actuator 20b and the fourth actuator 22b are electrically connected separate from the first actuator 15b and the second actuator 17b. The third actuator 20b and the fourth actuator 22b, which are electrically connected independently from the first actuator 5b and the second actuator 17b, are provided for axially displacing, via an operative connection with the switch gate 10b, the first cam element 12b and the second cam element 13b in the same switching direction 21b, the switching direction 21b being oriented opposite the switching direction 16b provided by the first actuator 15b and the second actuator 17b. A circuit for controlling the actuators 15b, 17b connected in series and the actuators 20b, 22b connected in series is closed only when all electrical connections between the actuators 15b, 17b or the actuators 20b, 22b and the control unit 18b are functional. Thus, controlling the actuators 15b, 17b or the actuators 20b, 22b is possible only when all electrical connections between the actuators 15b, 7b or the actuators 20b, 22b and the control and regulation unit 18b are functional. Controlling only one actuator 15b, 17b of the two actuators 15b, 7b, or only one actuator 20b, 22b of the two actuators 20b, 22b, is not possible. The actuators 15b, 17b or the actuators 20b, 22b connected in series may only be controlled jointly, or not at all.

The internal combustion engine valve drive device has a control unit 18b for simultaneously controlling the actuators 15b, 17b, 20b, 22b as a function of the switching direction 16b, 21b. The control and regulation unit 18b simultaneously controls either the first actuator 15b and the second actuator 17b or the third actuator 20b and the fourth actuator 22b, depending on the switching direction 16b, 21b to be switched. For axially displacing the two cam elements 12b, 13b in the switching direction 16b, the control unit 18b simultaneously controls only the actuators 15b, 17b, which are provided for providing the switching direction 16b. For axially displacing the two cam elements 12b, 13b in the switching direction 21b, the control unit 18b simultaneously controls only the actuators 20b, 22b, which are provided for providing the switching direction 21b. Thus, the control and regulation unit simultaneously controls only the actuators 15b, 17b, 20b, 22b which are provided for providing the desired switching direction 16b, 21b.

Due to the electrical connection of the actuators 15b, 17b in series and the electrical connection of the actuators 20b, 22b in series, when there is a defective or nonfunctional actuator 15b, 17b, 20b, 22b, for example in the event of a defective or disconnected electrical connection, a circuit through the actuators 15b, 17b connected in series or through the actuators 20b, 22b connected in series is interrupted, thus deactivating the corresponding two actuators 15b, 17b, 20b, 22b connected in series. In principle, the control unit 18b may additionally or alternatively monitor the actuators 15b, 17b, 20b, 22b, so that when a defective or nonfunctional actuator 15b, 17b, 20b, 22b is detected, all other actuators 15b, 17b, 20b, 22b are deactivated and a warning message is optionally provided.

The control unit 18a has two output stages 19b and 23b for controlling and monitoring all actuators 15b, 17b, 20b, 22b. The control unit has only one output stage 19b, 23b for each switching direction 16b, 21b, respectively. The output stage 19b is simultaneously connected to the first actuator 15b and the second actuator 17b, which are provided for axially displacing the two cam elements 12b, 13b in the same switching direction 16b. The output stage 23b is simultaneously connected to the third actuator 20b and the fourth actuator 22b, which are provided for axially displacing the two cam elements 12b, 13b in the same switching direction 21b.

In an operating state in which the cam elements 12b, 13b are to be axially displaced for lift switching in the switching direction 16b, the control unit 18b simultaneously activates only the actuators 15b, 17b connected in series. The control unit thus simultaneously controls only the actuators 15b, 17b which are provided for the desired switching direction 16b, so that coils are simultaneously energized only for the actuators 15b, 17b, and therefore the respective switch pins only of the actuators 15b, 17b are simultaneously extended. Coils of the actuators 20b, 22b, which are provided for providing the opposite switching direction 21b, remain de-energized. The switch pins of the actuators 15b, 17b, which are associated with the desired switching direction 16b, simultaneously engage with a corresponding gate track 31b, 33b, so that the actuator 15b and the actuator 17b are in operative connection with the switch gate 10b, and the cam elements 12b, 13b are sequentially axially displaced in the switching direction 16b due to the rotary motion 11b of a camshaft 24b. If an electrical connection between the actuators 15b, 17b is defective or disconnected, the circuit between the actuators 15b, 17b connected in series is interrupted, so that these actuators are de-energized and therefore deactivated. The axial displacement, and thus the lift switching, in the switching direction 16b is therefore interrupted or stopped, so that incomplete lift switching may be prevented and a defined state may be associated with the cam elements 12b, 13b. The same analogously applies for an operating state in which the cam elements 12b, 13b are to be axially displaced for lift switching in the switching direction 21b.

In principle, all actuators 15b, 17b, 20b, 22b which are provided for providing the two switching directions 16b, 21b may be electrically connected to one another in series. With reference to the above-described exemplary embodiment according to FIG. 2, the first actuator 15b, the second actuator 17b, the third actuator 20b, and the fourth actuator 22b would then be electrically connected to one another in series, regardless of which switching direction 16b, 21b they are provided for. The coils of all actuators 15b, 17b, 20b, 22b are connected in series. The actuators 15b, 17b are electrically independent from the actuators 20b, 22b. A circuit for controlling the actuators 15b, 17b, 20b, 22b is closed only when all electrical connections between the actuators 15b, 17b, 20b, 22b and the control and regulation unit 18b are functional. Thus, controlling the actuators 15b, 17b, 20b, 22b is possible only when all electrical connections between the actuators 15b, 17b, 20b, 22b and the control and regulation unit 18b are functional. Controlling only one, two, or three actuators 15b, 17b, 20b, 22b is not possible. Either only all actuators 15b, 17b, 20b, 22b may be jointly controlled, or none of the actuators 15b, 17b, 20b, 22b may be controlled. For axially displacing the cam elements 12b, 13b, the control and regulation unit 18b always simultaneously controls all actuators 15b, 17b, 20b, 22b, regardless of the switching direction 16b, 21b. For this purpose, the control and regulation unit 18b has a single output stage which is simultaneously connected to the first actuator 15b, to the second actuator 17b, to the third actuator 20b, and to the fourth actuator 22b. The control and regulation unit 18b thus has one output stage for both switching directions 16b, 21b.

What is claimed is:

1. An internal combustion engine valve drive device for a motor vehicle, having at least one switch gate (10a; 10b) which includes at least first and second cam elements (12a, 13a, 12b, 13b) for valve lift switching and is adapted to convert a rotary motion (11a; 11b) of the cam element (12a, 13a; 12b, 13b) into an axial motion (14a; 14b), a first actuator (15a; 15b) for axially displacing the first cam element (12a; 12b) in a switching direction (16a; 16b) via an operative connection with the switch gate (10a; 10b), a second actuator (17a; 17b) being provided for axially displacing a second cam element (13a; 13b) in the same switching direction (16a; 16b) via an operative connection with the switch gate (10a; 10b), and a control unit (18a; 18b) for controlling the axial displacement of the first and second cam elements (12a, 13a; 12b, 13b) in the same switching direction (16a; 16b), the control unit (18a; 18b) being provided for simultaneously controlling and/or monitoring the first and second actuators (15a, 17a; 15b, 17b).

2. The internal combustion engine valve drive device according to claim 1, wherein at least the first actuator (15a; 15b) and the second actuator (17a; 17b) are electrically connected to one another in one of a parallel and serial circuit arrangement.

3. The internal combustion engine valve drive device according to claim 1, wherein the control unit (18a; 18b) has a control or output stage (19a; 19b) which is simultaneously connected to the at least two actuators (15a, 17a; 15b; 17b), which are provided for axially displacing the at least two cam elements (12a, 13a; 12b, 13b) in the same switching direction (16a; 16b).

4. The internal combustion engine valve drive device according to claim 1, wherein for axially displacing the at least two cam elements (12a, 13a), the control unit (18a) is provided for simultaneously controlling and/or monitoring, regardless of a switching direction (16a, 21a) of the actuators (15a, 17a, 20a), the at least two actuators (15a, 17a) and at least a third actuator (20a), which is provided for axially displacing the first cam element (12a) and the second cam element (13a) in a switching direction (21a) oriented opposite the switching direction (16a) provided by the first actuator (15a) and the second actuator (17a), via an operative connection with the switch gate (10a).

5. The internal combustion engine valve drive device according to claim 1, wherein the valve drive device includes at least a third actuator (20a) which is electrically connected in one of a parallel and a series circuit arrangement to the first actuator (15a) and the second actuator (17a).

6. The internal combustion engine valve drive device according to claim 4, wherein the control and output stage (19a) is simultaneously connected to the actuators (15a, 17a, 20a), which are provided for axially displacing the at least two cam elements (12a, 13a) in the two oppositely oriented switching directions (16a, 21a).

7. The internal combustion engine valve drive device according to claim 1, wherein a third actuator (20b) which is connected electrically separate from the first actuator (15b) and the second actuator (17b) and which is provided for axially displacing the first cam element (12b) and the second cam element (13b) in a switching direction opposite to the switching direction (16b) provided by the first actuator (15b) and the second actuator (17b).

8. The internal combustion engine valve drive device according to claim 7, wherein a fourth actuator (22b) which is electrically connected in parallel or in series with the third actuator (20b), is provided for axially displacing the first cam element (12b) or the second cam element (13b) in the switching direction (21b) which corresponds to the switching direction (21b) provided by the third actuator (20b), via an operative connection with the switch gate (10b).

9. The internal combustion engine valve drive device according to claim 3, wherein the control unit (18b) has a further control and output stage (23b) which is connected at least to the third actuator (20b).

10. A method for valve lift switching in an internal combustion engine of a motor vehicle by means of an internal combustion engine valve drive device according to claim 1, comprising the steps of: displacing the first cam element (12a; 12b) axially in a switching direction (16a; 16b) by means of an operative connection of a first actuator (15a; 15b) with a switch gate (10a; 10b), and displacing a second cam element (13a; 13b) axially in the same switching direction (16a; 16b) by means of an operative connection of a second actuator (17a; 17b) with the switch gate (10a; 10b), and simultaneously controlling the first actuator (15a; 15b) and the second actuator (17a; 17b) for axially displacing the first and second cam elements (12a, 13a; 12b, 13b).
